(19) United States
(12) Patent Application Publication
(10) Pub. No.: US 2026/0326094 A1
(43) Pub. Date: Oct. 22, 2026

(54) MICRO TITRATION EXPERIMENTAL APPARATUS

(71) Applicants: Jiansuan Xinyu Technology (Shandong) Co., Ltd, Dongying (CN); Dongying Vocational Technical College, Dongying (CN); Zhongken Xiangweitang Agricultural Technology (Suzhou) Co., Ltd, Suzhou (CN); Guangzhou Meiyi Fresh Trading Co., Ltd, Guangzhou (CN)

(72) Inventors: Jiaqi WANG, Qingzhou (CN); Weikang WANG, Binzhou (CN); Qing CHEN, Xintai (CN); Jinjun LU, Suzhou (CN); Shuozan CHEN, Guangzhou (CN); Xiaojie SUN, Yantai (CN); Baoqiu LIANG, Binzhou (CN); Jianxin WU, Dongying (CN); Xiaojie LIU, Binzhou (CN); Ziheng XUE, Tai'an (CN); Mao CHEN, Binzhou (CN)

(21) Appl. No.: 19/646,651

(22) Filed: Apr. 14, 2026

(30) Foreign Application Priority Data
Apr. 22, 2025 (CN) 202510504116.7

(51) Int. Cl. B01L 3/02; B01L 9/00; G01F 23/80

(52) U.S. Cl. CPC B01L 3/0203; B01L 9/54; G01F 23/80; B01L 2200/021; B01L 2200/14; B01L 2300/0663; B01L 2400/0487

(57) ABSTRACT

Disclosed is a micro titration experimental apparatus, belonging to the technical field of chemical analysis experiments. A liquid level is monitored in real time through a liquid level sensor, and a titration control mechanism is controlled based on a detection value for titration. A controller enables a tiny gap appearing between a lower tip of a permanent magnetic core and a lower liquid discharge port of an inner layer dropper to be closed, and then a liquid level change value is read and recorded through the liquid level sensor, thereby achieving the automatic titration experiment analysis and improving the efficiency of the titration experiment.

### CROSS-REFERENCE TO RELATED APPLICATION

This application claims priority of Chinese Patent Application No. 202510504116.7, filed on Apr. 22, 2025, the entire contents of which are incorporated herein by reference.

### TECHNICAL FIELD

The present disclosure relates to the technical field of chemical analysis experiments, and in particular, to a micro titration experimental apparatus.

### BACKGROUND

Conventional titration is a commonly used chemical analysis method. Currently, manual titration is generally used for titration analysis in laboratories, which indicates a titration endpoint based on the color change of an indicator, then visually observes the volume consumed by a standard solution, and calculates an analysis result. This method of judging the titration endpoint based on the color change and determining the consumption of the standard solution by visually observing the volume can easily lead to a problem of an inaccurate analysis result, and at the same time, with a large amount of reagent dosage, this titration method can easily cause pollution and has a relatively high experimental cost.

To reduce the reagent dosage, and reduce pollution and costs, people have developed a micro titration method. A micro titration experiment conducted using the micro titration method is to obtain required chemical information by using as little reagent as possible in the premise of ensuring accuracy as much as possible. Usually, the reagent dosage of the micro titration experiment is only 1/10 to 1/1000 of that used in conventional experiments. Since the reagent dosage is reduced, the emission of “three wastes” in the laboratory is reduced, but the reduction of the dosage will inevitably increase experimental errors.

Thus, how to provide a micro titration experimental apparatus that can reduce the reagent dosage while not increasing the experimental error and improving the accuracy of the experiment is a technical problem to be solved in this field.

In the existing technology, the patent with the application No. CN201210442290.6 discloses a micro titration experimental apparatus, including an equal armed lever, a constant weight block arranged at one end of the equal armed lever, an electronic balance, and a titration device arranged at the other end of the equal armed lever. A lower portion of the constant weight block is connected to a weighing portion of the electronic balance, and the titration device includes a burette movably connected to the equal armed lever, and a titration vessel arranged below the burette. According to the micro titration experimental apparatus provided by the present disclosure, since the electronic balance has a high weighing accuracy, the technical solution for determining the concentration of a to-be-tested solution by the electronic balance measuring the weight of a titrating solution is not necessary to visually observe the volume change of the titrating solution as in the existing technology, which can not only reduce the dosage of the titrating solution, but also improve the accuracy of the experiment, reduce the cost and reduce the pollution to environments.

However, the existing titration device for experimental analysis is not convenient for automatic titration operations, and has a relatively long titration operation time when processing a large sample.

### SUMMARY

An objective of the present disclosure is to provide a micro titration experimental apparatus, to solve the problem that a conventional micro titration experimental apparatus is not convenient for automatic titration operations.

To solve the above-mentioned technical problem, the present disclosure uses the following technical solutions.

The present disclosure provides a micro titration experimental apparatus, including a base, an experimental vessel disposed on the base, a lifting adjustment mechanism disposed on the base, a burette disposed on the lifting adjustment mechanism, a liquid level sensor for detecting a liquid level in the burette, and a titration control mechanism disposed in the burette for controlling a titration amount.

Further, in this embodiment, a stirring mechanism is disposed above the experimental vessel through an adjustment bracket;

the adjustment bracket includes a support rod vertically fixed to the base, and an adjustment frame locked and limited on the support rod; and

the stirring mechanism includes a stirring motor disposed on the adjustment frame, a stirring shaft drivingly connected to the stirring motor, and a stirring blade disposed at a bottom of the stirring shaft.

Further, in this embodiment, the lifting mechanism includes two support plates disposed up and down, guide rods connected between the two support plates, a screw shaft disposed between the two support plates, a screw motor driving the screw shaft to rotate, and a screw sliding seat disposed on the guide rods and the screw shaft;

both ends of the screw shaft are disposed on the two support plates through bearings, respectively, and the guide rods are symmetrically disposed on both sides of the screw shaft; a screw nut adapted to the screw shaft is disposed in a middle of the screw sliding seat, and the screw sliding seat is also provided with guide sleeves adapted to the guide rods; and

an extended support frame I and an extended support frame II are symmetrically disposed on the screw sliding seat.

Further, in this embodiment, a lower bracket is disposed at a bottom of the lifting mechanism.

Further, in this embodiment, a sleeve is disposed at an end part of the extended support frame I, and a burette is limitedly disposed in the sleeve;

the burette includes an inner layer dropper and an outer layer sleeve tube coaxially sleeved outside the inner layer dropper; a flared liquid inlet is communicated at a top of the inner layer dropper;

the titration control mechanism includes a permanent magnetic core disposed in the inner layer dropper and used to block a lower liquid discharge port of the inner layer dropper, an electromagnetic coil disposed between the inner layer dropper and an interlayer of the outer layer sleeve tube, and a control power supply connected to the electromagnetic coil through a power supply wire; and

a corrosion-resistant layer is disposed outside the permanent magnetic core, and a plurality of support ribs that fit with an inner wall of the inner layer dropper are integrally formed on an upper end part of the corrosion-resistant layer; a lower end of the permanent magnetic core is of a tip structure, and the permanent magnetic core controls lifting after powered on by the electromagnetic coil.

Further, in this embodiment, a rotating shaft is disposed on the extended support frame I, the rotating shaft is adjusted and driven by a servo motor disposed at a bottom of the extended support frame I, and a rotating arm I and a rotating arm II are disposed at a top of the rotating shaft; a liquid injection tube corresponding to the liquid inlet is disposed on the rotating arm I, and the liquid level sensor corresponding to the liquid inlet is disposed on the rotating arm II.

Further, in this embodiment, a peristaltic pump is disposed on the extended support frame I; the peristaltic pump communicates with a titration solution storage tank through a liquid extraction tube, and a liquid discharge tube of the peristaltic pump communicates with the liquid injection tube.

Further, in this embodiment, a conductometer is also disposed in the experimental vessel, and the conductometer is connected to a conductivity display through a wire.

Compared with the existing technology, the beneficial technical effects of the present disclosure are:

In the present disclosure, the liquid level in the burette is monitored in real time by the liquid level sensor, and the titration control mechanism is controlled to perform titration based on a detection value of the liquid level sensor. The controller controls the control power supply to turn off the current provided by the electromagnetic coil by receiving a detection signal of the conductometer (or pH meter). The permanent magnetic core moves downward under the action of gravity, such that a tiny gap appearing between the lower tip of the permanent magnetic core and the lower liquid discharge port of the inner layer dropper is closed, and then a liquid level change value is read and recorded through the liquid level sensor, thereby achieving the automatic titration experiment analysis and improving the efficiency of the titration experiment.

### BRIEF DESCRIPTION OF THE DRAWINGS

The present disclosure will be further described below in conjunction with the accompanying drawings.

FIG. 1 is a schematic diagram of a main structure of a micro titration experimental apparatus according to the present disclosure;

FIG. 2 is a schematic diagram of a lifting adjustment mechanism of a micro titration experimental apparatus according to the present disclosure;

FIG. 3 is a schematic structural diagram of a burette of a micro titration experimental apparatus according to the present disclosure;

FIG. 4 is a partial enlargement view of portion A in FIG. 3; and

FIG. 5 is a schematic diagram of a B-B cross section in FIG. 4.

Description of reference numerals:1. Base; 11. Support rod; 12. Adjustment frame; 13. Stirring motor; 131. Stirring shaft; 132. Stirring blade; 2. Experimental vessel; 3. Lifting mechanism; 31. Support plate; 32. Screw motor; 33. Guide rod; 34. Screw shaft; 35. Screw sliding seat; 351. Extended support frame I; 352. Extended support frame II; 36. Lower bracket; 4. Peristaltic pump; 41. Liquid extraction tube; 42. Liquid discharge tube; 43. Flow valve; 5. Burette; 51. Liquid inlet; 52. Electromagnetic coil; 53. Permanent magnetic core; 531. Corrosion-resistant layer; 54. Outer layer sleeve tube; 55. Inner layer dropper; 6. Control power supply; 61. Power supply wire; 7. Titration solution storage tank; 8. Conductivity display; 81. Conductometer; 9. Servo motor; 91. Rotating arm I; 911. Liquid injection tube; 92. Rotating arm II; 921. Liquid level sensor.

### DETAILED DESCRIPTION

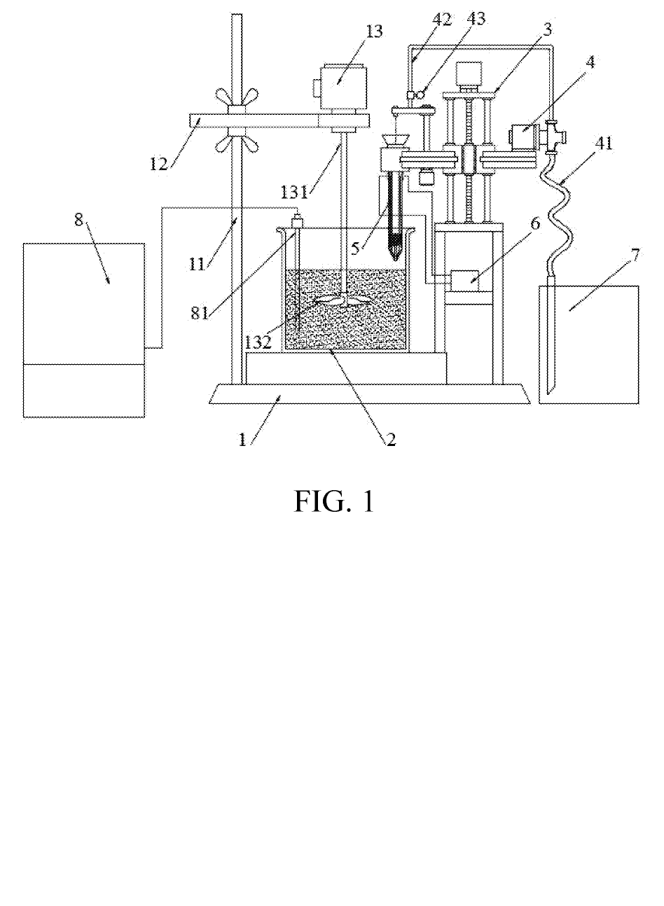

Referring to FIG. 1, this embodiment provides a micro titration experimental apparatus, including a base 1, an experimental vessel 2 disposed on the base 1, a lifting adjustment mechanism disposed on the base 1, a burette 5 mounted on the lifting adjustment mechanism, a liquid level sensor 921 for detecting a liquid level in the burette 5, and a titration control mechanism mounted in the burette 5 for controlling a titration amount.

During experiment, the liquid level in the burette 5 is monitored in real time by the liquid level sensor 921, and the titration control mechanism is controlled to perform titration based on a detection value of the liquid level sensor 921.

In this embodiment, a stirring mechanism is disposed above the experimental vessel 2 through an adjustment bracket; the adjustment bracket includes a support rod 11 vertically fixed to the base 1, and an adjustment frame 12 locked and limited on the support rod 11; and the stirring mechanism includes a stirring motor 13 disposed on the adjustment frame 12, a stirring shaft 131 drivingly connected to the stirring motor 13, and a stirring blade 132 mounted at a bottom of the stirring shaft 131, to speed up a reaction speed.

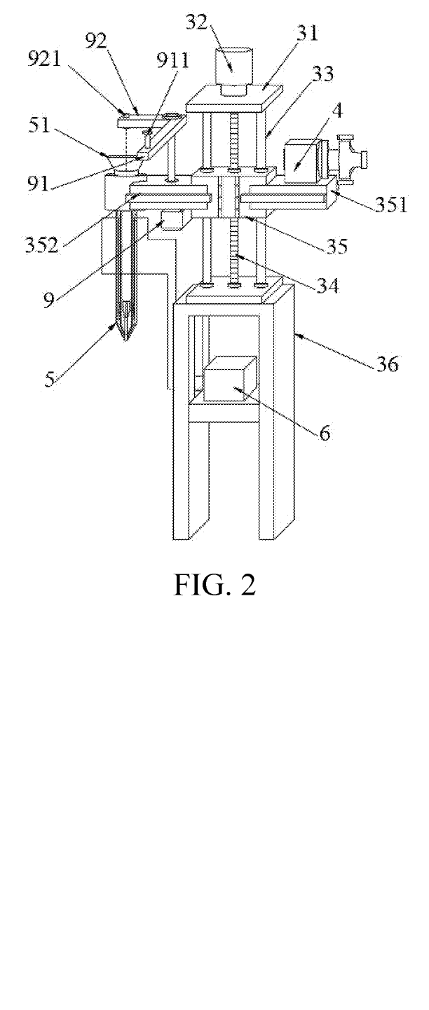

Referring to FIGS. 1 and 2, in this embodiment, the lifting mechanism 3 includes two support plates 31 disposed up and down, guide rods 33 connected between the two support plates 31, a screw shaft 34 mounted between the two support plates 31, a screw motor 32 driving the screw shaft 34 to rotate, and a screw sliding seat 35 mounted on the guide rods 33 and the screw shaft 34.

Both ends of the screw shaft 34 are mounted on the two support plates 31 through bearings, respectively, and the guide rods 33 are symmetrically mounted on both sides of the screw shaft 34; a screw nut adapted to the screw shaft 34 is mounted in a middle of the screw sliding seat 35, the screw sliding seat 35 is also provided with guide sleeves adapted to the guide rods 33; an extended support frame I 351 and an extended support frame II 352 are symmetrically mounted on the screw sliding seat 35.

By controlling the screw motor 32, the burette 5 mounted on the lifting adjustment mechanism is driven to approach to a liquid surface of the experimental vessel 2.

In this embodiment, a lower bracket 36 is mounted at a bottom of the lifting mechanism 3, and the lifting mechanism 3 is used to lift the position of the lifting mechanism 3, to facilitate the installation and assembly of the apparatus.

Referring to FIG. 2, a sleeve is mounted at an end part of the extended support frame I 352, and the burette 5 is limitedly mounted in the sleeve. The burette 5 includes an inner layer dropper 55 and an outer layer sleeve tube 54 coaxially sleeved outside the inner layer dropper 55; a flared liquid inlet 51 is communicated at a top of the inner layer dropper 55.

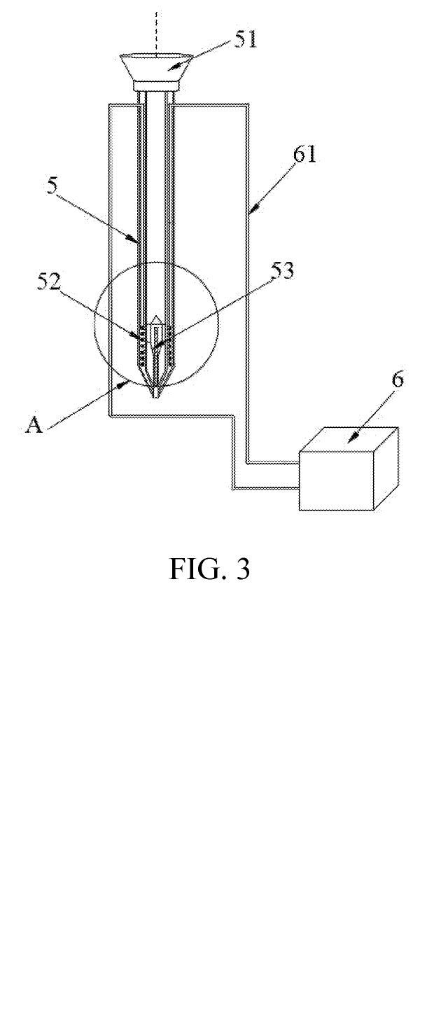

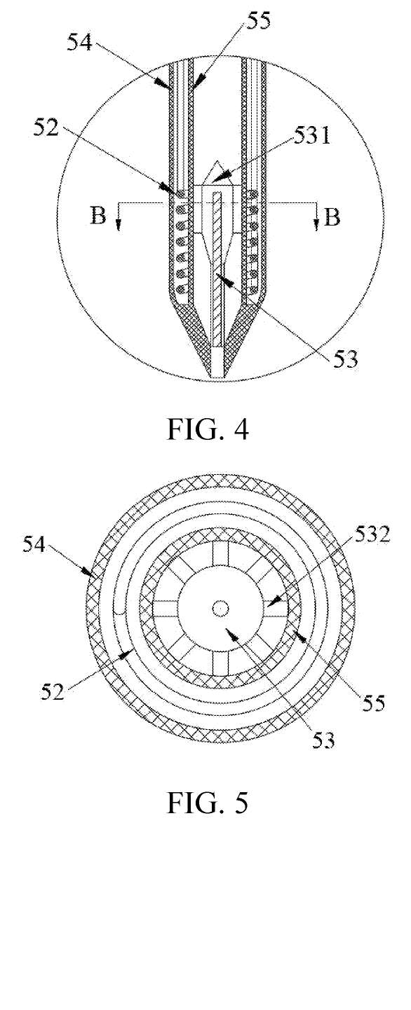

Referring to FIGS. 3 and 4, the titration control mechanism includes a permanent magnetic core 53 mounted in the inner layer dropper 55 and used to block a lower liquid discharge port of the inner layer dropper 55, an electromagnetic coil 52 mounted between the inner layer dropper 55 and an interlayer of the outer layer sleeve tube 54, and a control power supply 6 connected to the electromagnetic coil 52 through a power supply wire 61. A corrosion-resistant layer 531 is mounted outside the permanent magnetic core 53, and a plurality of support ribs 532 (referring to FIG. 5) that fit with an inner wall of the inner layer dropper 55 are integrally formed on an upper end part of the corrosion-resistant layer 531. A lower end of the permanent magnetic core 53 is of a tip structure, and the permanent magnetic core 53 controls lifting after powered on by the electromagnetic coil 52. The current provided by the control power supply 6 to the electromagnetic coil 52 through the power supply wire 61 needs to be sufficient to lift the permanent magnetic core 53 upward, such that a tiny gap appears between the lower tip of the permanent magnetic core 53 and the lower liquid discharge port of the inner layer dropper 55, and liquid drops flow out into the experimental vessel 2.

In this embodiment, the conductometer 81 (or pH meter) is mounted in the experimental vessel 2, the conductometer 81 is connected to a conductivity display 8 through a wire, and the conductometer 81 (or pH meter) also serves as a sensor. The controller controls the control power supply 6 to turn off the current provided by the electromagnetic coil 52 by receiving the detection signal of the conductometer 81 (or pH meter). The permanent magnetic core 53 moves downward under the action of gravity, such that the tiny gap appearing between the lower tip of the permanent magnetic core 53 and the lower liquid discharge port of the inner layer dropper 55 is closed, and then a liquid level change value is read and recorded through the liquid level sensor 921.

Referring to FIGS. 1 and 2, a rotating shaft is mounted on the extended support frame I 352, the rotating shaft is adjusted and driven by the servo motor 9 mounted at a bottom of the extended support frame I 352, and a rotating arm I 91 and a rotating arm II 92 are mounted at a top of the rotating shaft; a liquid injection tube 911 corresponding to the liquid inlet 51 is mounted on the rotating arm I 91, and the liquid level sensor 921 corresponding to the liquid inlet 51 is mounted on the rotating arm II 92.

A peristaltic pump 4 is mounted on the extended support frame I 351; the peristaltic pump 4 communicates with a titration solution storage tank 7 through a liquid extraction tube 41, and a liquid discharge tube 42 of the peristaltic pump 4 communicates with the liquid injection tube 911. Before titration, the titration solution is injected into the inner layer dropper 55 through the peristaltic pump 4.

The embodiments described above are only descriptions of the preferred modes of the present disclosure, instead of limiting the scope of the present disclosure. Without departing from the design spirit of the present disclosure, various modifications and improvements made to the technical solutions of the present disclosure by those of ordinary skill in the art should all fall within the protection scope determined by the claims of the present disclosure.

1. A micro titration experimental apparatus, comprising a base, an experimental vessel disposed on the base, a lifting adjustment mechanism disposed on the base, a burette disposed on the lifting adjustment mechanism, a liquid level sensor for detecting a liquid level in the burette, and a titration control mechanism disposed in the burette for controlling a titration amount.

2. The micro titration experimental apparatus according to claim 1, wherein a stirring mechanism is disposed above the experimental vessel through an adjustment bracket;
the adjustment bracket comprises a support rod vertically fixed to the base, and an adjustment frame locked and limited on the support rod; and
the stirring mechanism comprises a stirring motor disposed on the adjustment frame, a stirring shaft drivingly connected to the stirring motor, and a stirring blade disposed at a bottom of the stirring shaft.

3. The micro titration experimental apparatus according to claim 1, wherein the lifting mechanism comprises two support plates disposed up and down, guide rods connected between the two support plates, a screw shaft disposed between the two support plates, a screw motor driving the screw shaft to rotate, and a screw sliding seat disposed on the guide rods and the screw shaft;
both ends of the screw shaft are disposed on the two support plates through bearings, respectively, and the guide rods are symmetrically disposed on both sides of the screw shaft; a screw nut adapted to the screw shaft is disposed in a middle of the screw sliding seat, and the screw sliding seat is also provided with guide sleeves adapted to the guide rods; and
an extended support frame I and an extended support frame II are symmetrically disposed on the screw sliding seat.

4. The micro titration experimental apparatus according to claim 3, wherein a lower bracket is disposed at a bottom of the lifting mechanism.

5. The micro titration experimental apparatus according to claim 3, wherein a sleeve is disposed at an end part of the extended support frame I, and a burette is limitedly disposed in the sleeve;
the burette comprises an inner layer dropper and an outer layer sleeve tube coaxially sleeved outside the inner layer dropper; a flared liquid inlet is communicated at a top of the inner layer dropper;
the titration control mechanism comprises a permanent magnetic core disposed in the inner layer dropper and used to block a lower liquid discharge port of the inner layer dropper, an electromagnetic coil disposed between the inner layer dropper and an interlayer of the outer layer sleeve tube, and a control power supply connected to the electromagnetic coil through a power supply wire; and
a corrosion-resistant layer is disposed outside the permanent magnetic core, and a plurality of support ribs that fit with an inner wall of the inner layer dropper are integrally formed on an upper end part of the corrosion-resistant layer; a lower end of the permanent magnetic core is of a tip structure, and the permanent magnetic core controls lifting after powered on by the electromagnetic coil.

6. The micro titration experimental apparatus according to claim 5, wherein a rotating shaft is disposed on the extended support frame I, the rotating shaft is adjusted and driven by a servo motor disposed at a bottom of the extended support frame I, and a rotating arm I and a rotating arm II are disposed at a top of the rotating shaft; a liquid injection tube corresponding to the liquid inlet is disposed on the rotating arm I, and the liquid level sensor corresponding to the liquid inlet is disposed on the rotating arm II.

7. The micro titration experimental apparatus according to claim 6, wherein a peristaltic pump is disposed on the extended support frame I; the peristaltic pump communicates with a titration solution storage tank through a liquid extraction tube, and a liquid discharge tube of the peristaltic pump communicates with the liquid injection tube.

8. The micro titration experimental apparatus according to claim 1, wherein a conductometer is also disposed in the experimental vessel, and the conductometer is connected to a conductivity display through a wire.
